(19) United States
(12) Patent Application Publication
(10) Pub. No.: US 2022/0176313 A1
(43) Pub. Date: Jun. 9, 2022

(54) AIR TREATMENT SYSTEM

(71) Applicant: Honeywell International Inc., Charlotte, NC (US)

(72) Inventors: Daniel Pearce, Chard (GB); Ian Kerr, Broadway (GB)

(21) Appl. No.: 17/171,620

(22) Filed: Feb. 9, 2021

(30) Foreign Application Priority Data
Dec. 9, 2020 (GB) 2019421.3

(51) Int. Cl. B01D 53/22; C01B 21/04; B01D 53/86; B01D 46/44; B01D 46/00; B64D 13/00; B64D 37/00

(52) U.S. Cl. CPC B01D 53/229; C01B 21/0494; B01D 53/8675; B01D 46/44; B01D 46/0086; B64D 13/00; B01D 2279/40; C01B 2210/0092; C01B 2210/0045; C01B 2210/001; C01B 2210/0006; B01D 2257/106; B64D 37/005

(57) ABSTRACT

In some examples, an air treatment system includes a filter, an ozone sensor, and a separator configured to separate air into a nitrogen-enriched gas and an oxygen-enriched gas. The filter is configured to remove ozone from an air stream and supply filtered air to the separator. The ozone sensor is configured to sense an ozone level of the filtered air issuing from the filter prior to encountering the separator. The air treatment system may include processing circuitry configured to monitor the ozone level sensed. The air treatment system may be part of an inerting system configured to supply the nitrogen-enriched gas to an ullage space of a fuel tank.

### STATEMENT REGARDING FEDERALLY SPONSORED RESEARCH OR DEVELOPMENT

This invention was made with non-US Government support under Contract No. 113109 awarded by (UK ATI)—United Kingdom—Aerospace Technologies Institute/UKRI (Innovate UK). The Government may have certain rights in the invention.

This application claims priority to GB Application No. 2019421.3 filed Dec. 9, 2020, the entire content of which is incorporated herein by reference.

### TECHNICAL FIELD

The present disclosure relates to air separation systems, such as air separation systems on-board an aircraft.

### BACKGROUND

An inerting system may supply nitrogen-enriched air to an ullage space of an on-board fuel tank on an aircraft. The inerting system may generate the nitrogen-enriched air using air originating from outside the aircraft, such as bleed air from an aircraft engine. The inerting system may be configured to supply the nitrogen-enriched air to the fuel tank as a volume of the ullage space increases, for example over the course of an aircraft flight.

### SUMMARY

In examples, an air treatment system is configured to separate air into a nitrogen-enriched gas and an oxygen-enriched gas. The air treatment system may be included in an inerting system configured to supply the nitrogen-enriched air to an ullage space of a fuel tank (e.g., onboard an aircraft). The air treatment system may include a filter, an ozone sensor, and a separator. The filter may be configured to remove ozone and other substances such as hydrocarbons, water, and/or particulates from a stream of air and supply filtered air to the separator. The ozone sensor may be configured to sense an ozone level within the filtered air issuing from the filter prior to the filtered air reaching the separator. The air treatment system may include processing circuitry configured to monitor the ozone level sensed in the filtered air. Thus, the air treatment system may be configured to indicate when the filter is failing to reduce the ozone in the filtered air to a desired level, prior to the filtered air encountering the separator. The processing circuitry may be configured to alert an operator that the filter should be replaced and/or maintained to substantially minimize an ozone exposure of the separator.

In examples, an air treatment system comprises: a filter configured to receive a flow of treated air comprising ozone and generate a flow of filtered air, wherein the flow of filtered air comprises a lower concentration of ozone than the flow of treated air; a separator configured to receive the flow of filtered air from the filter, wherein the separator is configured to separate the flow of filtered air into a flow of nitrogen-enriched gas and a flow of oxygen-enriched gas; and an ozone sensor configured to detect an ozone level in the flow of filtered air.

In examples, an air treatment system comprises: a filter assembly comprising: a filter configured to reduce an ozone level in a flow of air when the flow of air encounters the filter; a filter inlet configured to receive treated air comprising ozone and cause the treated air to encounter the filter; and a filter outlet configured to channel filtered air from the filter, wherein the filtered air comprises a lower concentration of ozone than the treated air; a separator assembly comprising: an air separation membrane configured to separate the filtered air into a nitrogen-enriched gas and an oxygen-enriched gas when the filtered air encounters the air separation membrane; a separator inlet configured to receive filtered air from the filter outlet and cause the filtered air to encounter the membrane; and a separator outlet configured to channel the nitrogen-enriched gas from the membrane; and an ozone sensor configured to detect an ozone level of the filtered air received by the separator inlet.

An example technique for separating an air stream into a nitrogen-enriched gas and an oxygen-enriched gas is additionally described herein.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a schematic illustration of an inerting system of an aircraft.

FIG. 2 schematically illustrates an example operation of an inerting system.

FIG. 3 is a schematic illustration of an inerting system and an example air treatment system.

FIG. 4 is a schematic illustration of one or more ozone levels detected by an ozone sensor.

FIG. 5 is a schematic illustration of an inerting system and an example air treatment system having an ozone sensor within a separator housing.

FIG. 6 is a flow diagram illustrating an example method of generating a nitrogen-enriched gas.

### DETAILED DESCRIPTION

The disclosure describes articles, systems, and techniques relating to an air treatment system and in particular, an apparatus including one or more structures configured to reduce an ozone level in the air treatment system. The air treatment system may be an air separation system configured to receive an air stream and separate the air stream into nitrogen-enriched air and oxygen-enriched air using a filter (e.g., an air separation module filter (ASM filter)) and a separator (e.g., an air separation module (ASM)). The separator may include an air separation membrane. The filter may be configured to reduce the amount of ozone and/or other substances in the air stream (e.g., hydrocarbons, water, particulates) before the air stream encounters the separator. The filter may be configured to reduce an ozone exposure of the separator in to, for example, reduce the impact of ozone on the operating life of the separator (e.g., reduce corrosion of plastics and rubbers included in the separator).

The air treatment system includes an ozone sensor configured to sense an ozone level in the filtered air stream discharging from the filter. The ozone level may be an ozone concentration, an ozone amount (e.g., a mass), or some other parameter indicative of the ozone level in the filtered air stream. The ozone sensor is configured to sense the ozone level prior to the filtered air stream encountering the air separation apparatus (e.g., the air separation membrane) of the separator. Hence, the air treatment system may be configured to monitor the ozone removal performance of the filter, in order to limit and/or avoid subjecting the separator to higher ozone levels. For example, the air treatment system may be configured to identify an end-of-life criteria for the filter based on an ozone level of the filter effluent. The air treatment system may be configured to alert an operator to the end-of-life criteria to generate, for example, an indication that maintenance and/or replacement of the filter should be performed to avoid subjecting the separator to increased ozone levels.

Ozone levels in air treatment systems may have adverse effects on components within inerting and/or air treatment systems. For example, continued exposure to ozone may cause corrosion of plastics, rubbers, and other materials within the system. Further, some inerting and/or air treatment systems may rely on air separation membranes for the separation of air into a nitrogen-enriched and oxygen-enriched gases. Some air separation membranes may be particularly susceptible to degradation when exposed to higher ozone levels. Replacement of a degraded air separation membrane may be more difficult and/or costly than replacing other ozone removing components. Hence, it may be more cost-effective to monitor the ozone removal capability of a component upstream of the air separation membrane, such as a filter, and take action to replace and/or repair the filter when the ozone level increases. Replacing and/or repairing the filter may reduce the ozone level upstream of the air separation membrane, reducing the ozone exposure and potentially prolonging an operating life of the air separation membrane. Hence, monitoring an ozone level immediately downstream of the filter and upstream of an air separation apparatus may serve to alert an operator when replacement and/or repair of the filter may be appropriate to minimize potential ozone exposure to the air separation apparatus, such as an air separation membrane.

In examples, the air treatment system includes processing circuitry configured to receive a signal indicative of the ozone level sensed by the ozone sensor. The processing circuitry may be configured to generate an output indicating the ozone level based on the indicative signal. In examples, the processing circuitry is configured to receive one or more indicative signals over a time period (e.g., over one or more operating cycles of the air treatment system). The processing circuitry may be configured to store the one or more indicative signals and/or the time period in a memory accessible by an operator. In examples, the processing circuitry is be configured to integrate the one or more indicative signals over the time period to determine an ozone dose (e.g., a total quantity of ozone) delivered to the separator over the time period. In examples, the processing circuitry is configured to determine an ozone level trend based on the one of more indicative signals and the time period. The processing circuitry may be configured to determine other parameters using the one or more indicative signals and the time period. Thus, the air treatment system may be configured to generate an indication that the filter may be at or approaching an end-of-life criteria based on the determination of a discrete ozone level sensed, and/or based on one or more parameters reflecting the zone level over a time period (e.g., an ozone dose).

The air treatment system may be configured as part of an Inert Gas Generation System (IGGS) configured to deliver at least a portion of the nitrogen-enriched air to a fuel tank (e.g., on an aircraft). The air treatment system may be configured to substantially generate the nitrogen-enriched air for the IGGS. In examples, the air treatment system is part of an IGGS configured to supply the nitrogen-enriched air to a fuel tank ullage as fuel is expended (e.g., by an aircraft engine). In examples, the IGGS includes an ozone converter configured to initially receive the air stream (e.g., as bleed air from an aircraft engine) and reduce the ozone level of the air stream. For example the ozone converter may be configured to reduce the ozone level by converting some portion of the ozone (O₃) to diatomic oxygen (O₂). The ozone converter may be configured to supply a stream of treated air, with the stream of treated air comprising less ozone that the air stream received by the ozone converter. In examples, the ozone converter includes a housing defining an inlet (“OC inlet”) and an outlet (“OC outlet”). The ozone converter may be configured to receive an air stream via the OC inlet and discharge treated air via the OC outlet.

The filter may be configured to receive at least some portion of the treated air from the ozone converter. The filter may be configured to remove at least some portion of the ozone remaining within the treated air after passage through the ozone converter, as well as other substances such as hydrocarbons, water and particulates. In examples, the filter is configured to receive treated air from the ozone converter on an influent side of the filter and generate filtered air from an effluent side opposite the influent side, with the filtered air having an ozone level (e.g., an ozone concentration) less than the treated air. In examples, a filter assembly mechanically supports the filter and defines an inlet (filter inlet”) and an outlet (“filter outlet”). The filter assembly may be configured to receive a flow of treated air through the filter inlet (e.g., from the OC outlet) and discharge a flow of filtered air through the filter outlet. Hence, the filter may be configured to generate a filtered air having reduced concentrations of ozone, hydrocarbons, water, particulates and/or other substances compared to the treated air generated by the ozone converter.

The ozone sensor is configured to sense an ozone level in the filtered air. In examples, the ozone sensor is configured to sense the ozone level of the filtered air after the filtered air exits an effluent side of the filter. Hence, the ozone sensor may be configured to indicate the ozone removal performance of the filter. In examples, the ozone sensor is configured to sense the ozone level of the filtered air prior to the filtered air encountering the separator. The ozone sensor may be configured to substantially monitor the ozone level of the filtered air entering the separator, in order to determine an amount of ozone proceeding into the separator (e.g., an instantaneous amount and/or an amount over a time period). The ozone sensor may be configured to generate a signal based on the sensed ozone level. Hence, the ozone sensor may be configured to generate a signal indicative of the performance of the filter, based on the ozone level in the filtered air issuing from an effluent side of the filter.

The ozone sensor may be configured to generate the indicative signal to processing circuitry. The processing circuitry may be configured to interpret the signal substantially instantaneously and/or over some time period. The processing circuitry may be configured to determine an end-of-life criteria for the filter, based on the indicative signal. For example, the processing circuitry may be configured to determine the end-of-life criteria based on a substantially instantaneous signal, one or more indicative signals received over a time period, or some other criteria based on indicative signals received from the ozone sensor. The processing circuitry may be configured to determine an ozone level based on the indicative signal from the ozone sensor, either solely or in combination with signals received from gas sensing equipment elsewhere in an inerting and/or air treatment system. The processing circuitry may be configured to generate an output to an operator indicating the end-of-life criteria. Thus, the air treatment system may be configured to indicate an end-of-life criteria has been detected for the filter, and that maintenance and/or replacement may be required in order to limit the ozone exposure of the separator receiving filter air from the filter.

The separator may be configured to receive some portion of the filtered air generated by the filter. The separator may include one or more air separation membranes configured to separate the filtered air from the filter into the nitrogen-enriched air and the oxygen-enriched air. For example, the air separation membrane may be a selectively permeable membrane which substantially discriminates between oxygen and inert gases, such as nitrogen. In examples, the air separation membrane is configured such that, as the filtered air encounters a retentate side of the air separation membrane, oxygen from the filtered air passes (e.g., preferentially over nitrogen) from the retentate side to a permeate side opposite the retentate side. The separator may include a housing (“separator housing”) mechanically supporting the one or more membranes. In examples, the separator housing defines an inlet (“separator inlet”) configured to receive filtered air from the filter (e.g., from the filter outlet). The separator housing may be configured to cause filtered air received via the separator inlet to encounter the retentate side of the air separation membrane. The separator housing may define an outlet (“separator outlet”) configured to discharge the nitrogen-enriched air from the retentate side of the air separation membrane. In examples, the separator housing defines a permeate vent configured to discharge the oxygen-enriched air from the permeate side of the air separation membrane.

The separator may be configured to supply the nitrogen-enriched air to a volume (e.g., an ullage) defined by a fuel tank. In examples, the separator is configured to supply the nitrogen-enriched air from the separator outlet to an inlet of the fuel tank (“fuel tank inlet”) via an conduit in fluid communication with the separator outlet and the fuel tank inlet. Hence, the air treatment system may be configured to receive a stream of air (e.g., treated air from an ozone converter) and separate the stream of air into nitrogen-enriched air and oxygen-enriched air. The air treatment system may be configured to remove some portion of ozone within the stream of air using a filter, prior to causing the stream of air to encounter the separator. The air treatment system may be configured to substantially monitor an ozone level of the stream of air between the filter and the separator, in order to monitor the ozone-removing capability of the filter and limit the ozone exposure to the downstream separator. The air treatment system may be included in an IGGS system on-board an aircraft configured to deliver some portion of the nitrogen-enriched air to one or more aircraft fuel tanks.

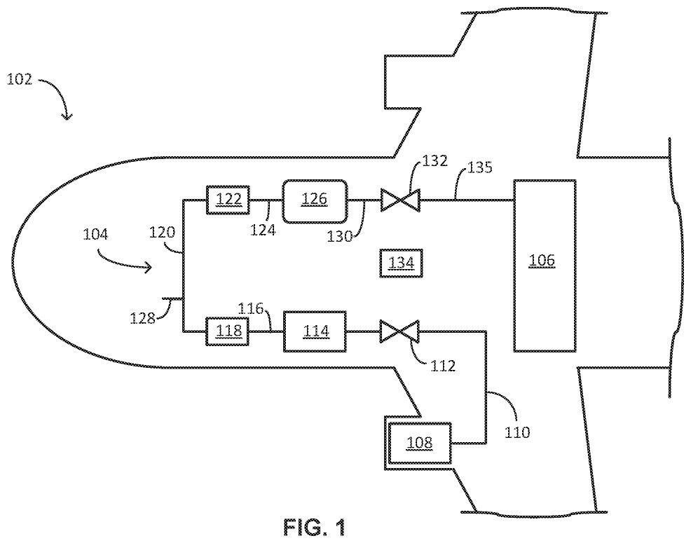

FIG. 1 schematically illustrates an example aircraft 102 including an inerting system 104 configured to supply nitrogen-enriched air to a fuel tank 106 of aircraft 102. Fuel tank 106 defines a volume configured to contain a combustible fuel. Fuel tank 106 may be part of a fuel delivery system configured to deliver the fuel for combustion in an aircraft engine 108. As engine 108 consumes fuel (e.g., over the course of a flight), an ullage space may develop within fuel tank 106. The ullage space may be a volume defined by an interior of fuel tank 106 and a surface of the combustible fuel within fuel tank 106. The volume of the ullage space may increase as additional fuel is expended (e.g., over the course of an aircraft flight). Inerting system 104 is configured to separate an air stream into a nitrogen-enriched stream and an oxygen-enriched stream, and deliver the nitrogen-enriched stream to the ullage space of fuel tank 106. Inerting system 104 is configured to deliver the nitrogen-enriched stream to produce a substantially non-combustible mixture of gases within the ullage space of fuel tank 106.

Inerting system 104 may be configured to condition the air stream prior to affecting a separation of the air stream. For example, inerting system 104 may be configured to reduce an ozone concentration of the air stream to protect components of inerting system 104 from deleterious effects (e.g., corrosion of plastics and rubbers) and other reasons. In some examples, portions of inerting system 104 are configured to supply air to an Environmental Control System (ECS) configured to control an atmosphere within a passenger cabin and/or cockpit of aircraft 102. Portions of inerting system 104 may be configured to reduce the ozone concentration of the air stream below a certain limit (e.g., a ppb limit) to minimize ozone levels within the passenger cabin and/or cockpit.

Inerting system 104 may be configured to receive an air stream from an atmosphere surrounding aircraft 102. Inerting system 104 may include an inlet conduit 110 configured to deliver the air stream. In examples, inlet conduit 110 is configured to receive the air stream from engine 108 of aircraft 102 (e.g., bleed air from engine 108). The air stream received by inlet conduit 110 may include oxygen and nitrogen (e.g., about 21% oxygen and 79% nitrogen) as well as other gases and/or substances, such as ozone, argon, carbon dioxide, water (e.g., water vapor), dust particles, and/or other matter and aerosols typically present in the atmosphere. In examples (e.g., when inlet conduit 110 receives bleed air from aircraft engine 108), the air stream may include hydrocarbons and other volatile organic compounds such as jet fuel, engine lubricating oil, hydraulic fluid, de-icing agents, and other contaminants present in the atmosphere, on the ground, and at altitude. Inlet conduit 110 may be configured to deliver an air stream at any temperature. In examples (e.g., when inlet conduit 110 is configured to receive an engine bleed air), inlet conduit 110 is configured to deliver an air stream having a temperature of about 300° F. to about 500° F. (about 149° C. to about 260° C.).

A system inlet valve 112 may be in-line with inlet conduit 110 and configured to control the flow of air through inlet conduit 110. For example, inlet valve 112 may be configured to throttle or cease the flow of air through inlet conduit 110. Inlet conduit 110 is configured to deliver the air stream via inlet valve 112 to an ozone converter 114. Ozone converter 114 may be configured to reduce an ozone concentration of the air stream. Ozone converter 114 may be configured to reduce the ozone concentration in order to limit the ozone exposure of one or more downstream components of inerting system 104, drive the ozone concentration below a certain level desired for atmosphere control of a passenger cabin and/or cockpit of airplane 102, and/or other reasons. Ozone converter 114 may be configured to supply a flow of treated air, wherein the treated air has a lower ozone concentration than the air stream supplied via inlet conduit 110. In examples, ozone converter 114 is configured to supply a flow of the treated air (e.g., via conduit 116) to a heat exchanger 118 configured to reduce the temperature of the treated air. For example, heat exchanger 118 may be configured to cool the treated air from a temperature of about 300° F. To 500° F. (about 149° C. to about 260° C.) to a temperature of about 180° F. To 200° F. (about 82° C. to about 93° C.).

Inerting system 104 may be configured to supply a stream of treated air (e.g., via conduit 120) to a filter 122 (e.g., an ASM filter) and a separator 126 (e.g., an ASM), in order to generate the nitrogen-enriched stream for substantially inerting the ullage space of fuel tank 106. Inerting system 104 may be further configured to divert some portion of the treated air to an ECS via ECS outlet 128 in order to, for example, control an environment in a passenger cabin, cockpit, and/or some other compartment of aircraft 102. Filter 122 may be configured to remove some portion of the ozone remaining within the treated air after passage through ozone converter 114 and heat exchanger 118, as well as other substances such as hydrocarbons, water, and/or particulates. In examples, filter 122 is a High-Efficiency Particulate Arrestance (HEPA) filter. Filter 122 may be configured to encounter the stream of treated air on an influent side and supply a flow of filtered air on an effluent side opposite the influent side. The filtered air issuing from the effluent side may have a lower concentration of ozone than the treated air, as well as a lower concentration of the other substances removed by filter 122.

Separator 126 may be configured to receive a flow of filtered air (e.g., via conduit 124) from filter 122. Separator 126 may be configured to separate the filtered air into a nitrogen-enriched stream and an oxygen-enriched stream. The nitrogen-enriched stream has a greater concentration of nitrogen (N2) than the filtered air. The oxygen-enriched stream has a greater concentration of oxygen than the filtered air. In examples, the air separation membrane includes a selectively permeable membrane which configured to preferentially permeate oxygen over nitrogen. Separator 126 may be configured to supply a stream of the nitrogen-enriched air to an ullage space of fuel tank 106. For example, separator 126 may be configured to supply the stream of the nitrogen-enriched air to fuel tank 106 via conduit 135 and system outlet valve 132.

In examples, inerting system 104 may include processing circuitry 134 configured to communicate with one or more components of inerting system 104. Processing circuitry 134 may be configured to control the operation of one or more components of inerting system 104 based on, for example, one or more communications received from an onboard control system of aircraft 102. For examples, processing circuitry 134 may be configured to control the operation of inlet valve 112 and/or outlet valve 132 to control a flow through inerting system 104, control one or more components associated with heat exchanger 118 to control a temperature of the treated air, and/or control some other operation conducted by inerting system 104. Further, inerting system 104 may include additional components configured to interact with and/or alter the properties of a flow passing through inerting system 104. For example, the additional components may include filters, heat exchangers, additional valves, water extraction devices, and other components configured to alter a composition, thermodynamic state, and/or other property of the air stream passing through inlet conduit 110.

Additionally, although illustrated at FIG. 1 as substantially separate components, one or more of inlet valve 112, ozone converter 114, heat exchanger 118, filter 122, separator 126, and/or outlet valve 132 may be configured within a mechanically unified housing (e.g., a substantially unitary housing and/or two or more housings mechanically engaged to behave as a substantially rigid body). For example, inerting system 104 may include a mechanically unified housing configured to mechanically support both filter 122 and separator 126. Inerting system 104 may include a mechanically unified housing configured to mechanically support both filter 122 and separator 126. Inerting system 104 may be configured to define some portion or substantially all of inlet conduit 110, conduit 116, conduit 120, conduit 124, and/or conduit 135 within one or more mechanically unified housings.

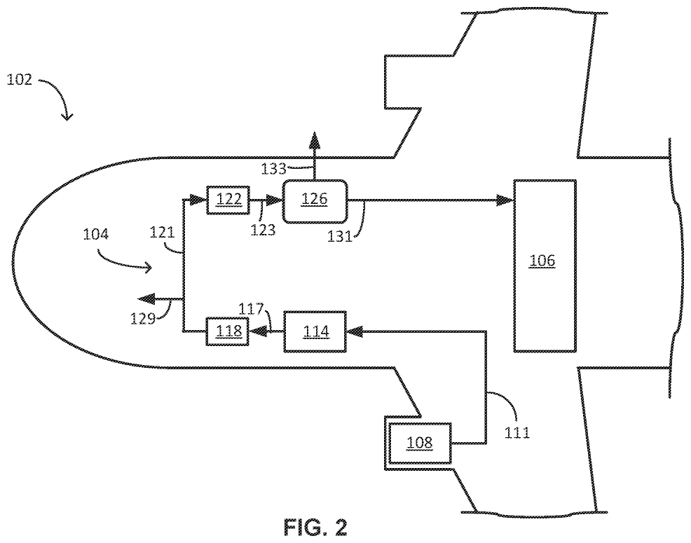

FIG. 2 illustrates example flow paths that may be present within inserting system 104. Ozone converter 114 may receive an air stream 111 from, for example, engine 108. Ozone converter may remove reduce an ozone level of air stream 111 and supply treated air 117 to heat exchanger 118. Heat exchanger 118 may condition treated air 117 and supply treated air 121 to filter 122. In examples, heat exchanger 118 and/or ozone converter 114 supplies treated air 129 to an ECS. In examples, ozone converter 114 supplies the treated air 117 to filter 122. Filter 122 may remove another portion of ozone from treated air 117, 121 and supply filtered air 123 to separator 126. Separator 126 may separate filtered air 123 into nitrogen-enriched stream 131 and oxygen-enriched stream 133. Air separation apparatus may supply nitrogen-enriched stream 131 to fuel tank 106. Inerting system 104 may direct oxygen-enriched stream 133 off-board aircraft 102 or elsewhere.

Hence, inerting system 104 may be configured to receive a stream of air (e.g., bleed air from engine 108) and separate the stream of air into nitrogen-enriched air and oxygen-enriched air. Inerting system 104 may be configured to supply the nitrogen-enriched air to fuel tank 106, to substantially inert an ullage space within fuel tank 106 (e.g., as fuel is consumed from fuel tank 106). Inerting system may be configured to remove some portion of the ozone within the stream of air using a filter, prior to causing the stream of air to encounter the separator.

As discussed, filter 122 may be configured to remove an amount of ozone and other substances from the treated air exiting ozone converter 114, in order to reduce the ozone exposure of downstream components such as separator 126. In examples, inerting system 104 is configured to sense an ozone level in the filtered air exiting filter 122 and entering separator 126, in order to monitor an ozone removal performance of filter 122 and/or ozone converter 114. For example, inerting system 104 may be configured to sense an ozone level of the filtered air within conduit 124. Ozone sensing of the filtered air between filter 122 and separator 126 may allow a determination that filter 122 is at or approaching an end-of-life criteria and allowing a greater concentration of ozone to reach separator 126 than may be desired. Identifying the ozone removal performance of filter 122 may indicate a need to replace and/or maintain filter 122 to reduce the ozone exposure of separator 126, potentially extending the operational life of separator 126 (e.g., an air separation membrane within separator 126).

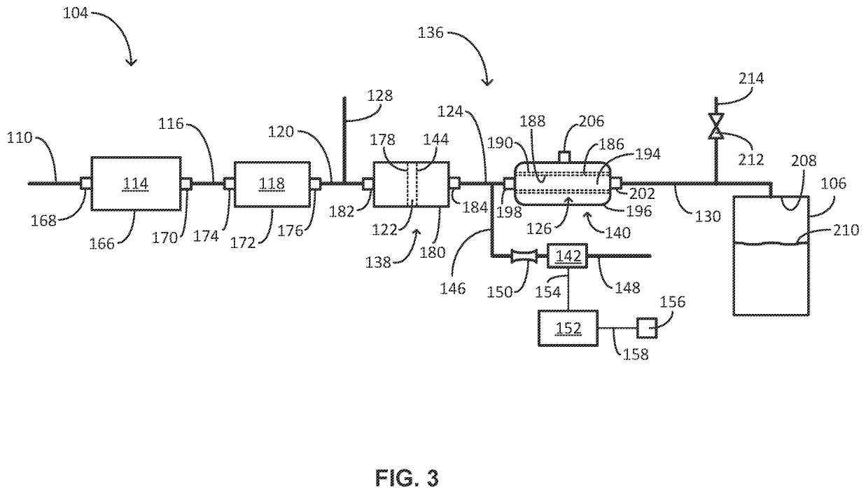

FIG. 3 schematically illustrates an example of inerting system 104 configured to sense an ozone level of a filtered air. Inerting system 104 includes air treatment system 136 including filter assembly 138 mechanically supporting filter 122, separator assembly 140 mechanically supporting separator 126, and conduit 124 configured to direct filtered air from filter 122 to separator 126. Filter 122 and separator 126 are shown in dashed lines in FIG. 3.

Air treatment system 136 includes an ozone sensor 142 configured to sense an ozone level of filtered air using from an effluent 144 of filter 122 (“filter effluent 144”). Ozone sensor 142 may be configured to sense the ozone level prior to the filtered air contacting separator 126. In examples, ozone sensor 142 is configured to sense an ozone level of filtered air within conduit 124. For example, air treatment system 136 may include a sample line 146 configured to direct a portion of the filtered air from conduit 124 to ozone sensor 142 in order to determine the ozone level of the filtered air within conduit 124. Sample line 146 may be configured to cause the portion of the filtered air to interact with ozone sensor 142 in a manner causing ozone sensor 142 to generate a measurement indicating the ozone level. In some examples, sample line 146 may be configured to discharge the portion of the filtered air to an environment surrounding air treatment system 136 and/or inerting system 104 via a sample outlet 148. In some examples, sample line 146 may be configured as a sample loop, such that sample outlet 148 returns the portion of filtered air to air treatment system 136 and/or inerting system 104 (e.g., returns the portion of filtered air to conduit 124 and/or conduit 130). In some examples, as will be discussed, air treatment system 136 may be configured such that ozone sensor 142 is a substantially in-line sensor configured to encounter filtered air within conduit 124. In examples, sample line 146 may include a flow regulator 150 configured to control the flow of filtered air through sample line 146.

Ozone sensor 142 may be configured to determine an ozone level in any manner. For example, ozone sensor 142 may include conductive carbon nanotubes (CNT) and/or a CNT-based composite configured to detect ozone. Ozone sensor 142 may include single-wall carbon nanotubes (SWCNT) or a multiwalled carbon nanotubes (MWCNT). In examples, ozone sensor 142 includes a metal oxide such as a zinc oxide (e.g., ZnO), a tungsten oxide, a (e.g., WO3), a tin oxide (e.g., SnO2), indium oxide (e.g., In2O3), a nickel oxide (e.g., NiO), and/or others. Ozone sensor 142 may include a p-type and/or n-type semiconductor. In examples, ozone sensor 142 is a heated metal oxide sensor (HMOS). In some example, ozone sensor 142 is an electrochemical sensor including an electrolyte configured to interact with ozone. In some examples, ozone sensor 142 is configured to provide UV illumination of a material (e.g., a thin film) and determine the ozone level based on a UV absorbance. Ozone sensor 142 may be configured to generate a signal indicative of the ozone level based on an electrical parameter (e.g., a voltage, conductivity, resistivity, or other parameter) of ozone sensor 142. Ozone sensor 142 may further include additional components (e.g., power inputs, heaters, reference and/or working electrode) necessary to cause ozone sensor 142 to determine an ozone level.

Ozone sensor 142 may be configured to generate a signal indicative of the ozone level sensed to processing circuitry 152 (e.g., via communication link 154). Processing circuitry 152 may be included within processing circuitry 134 (FIG. 1), or may be substantially separate from processing circuitry 152. Processing circuitry 142 may be configured to receive the indicative signal from ozone sensor 142. In examples, processing circuitry 152 is configured to communicate an output to an output device 156 (e.g., via communication link 158) based on the indicative signal received from ozone sensor 142. Air treatment system 136 may be configured to generate one or more indications of a sensed ozone level using output device 156. Output device 156 may be, for example, an output port configured to generate data indicative of the ozone level to an external device, such as a tablet computer, personal digital assistant, router, modem, remote server, cloud computing device, and the like. Output device 156 may be configured to a generate data indicative of the ozone level to another computing system installed on-board an aircraft (e.g., aircraft 102 (FIG. 1)). In examples, output device 156 is a gauge or other display configured to display a visual indication of an ozone level to an operator.

Processing circuitry 152 may be configured to generate an output via output device 156 based on a one or more indicative signals received from ozone sensor 142. In examples, processing circuitry 152 is configured to receive one or more indicative signals over a time period (e.g., over one or more operating cycles of air treatment system 136 and/or inerting system 104). Processing circuitry 152 may be configured to store the one or more indicative signals and/or the time period in a memory. The memory may be accessible by an operator using output device 156. Processing circuitry 152 may be configured to access the memory to retrieve one or more signals received in order to, for example, generate an indication of an ozone level at one or more specific times within the time period. In examples, processing circuitry 152 is configured to integrate the one or more indicative signals over the time period to determine a total ozone dose over the time period. In examples, the processing circuitry 152 is configured to determine an ozone level trend based on the one of more indicative signals and the time period. Processing circuitry 152 may be configured to determine other parameters using the one or more indicative signals and/or a time period. Processing circuitry 152 may be configured to determine an ozone level using the indicative signal from sensor 142 and one or more signals representative of another physical measurement, such as a temperature, a carbon-dioxide (CO₂) level, a pressure, a contaminant level, a humidity level, or some other physical measurement.

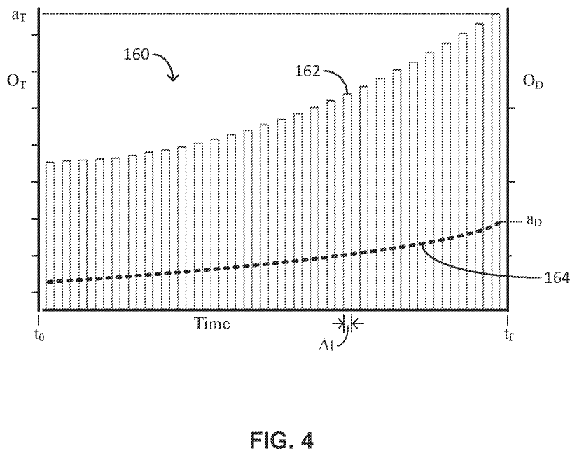

For example, FIG. 4 represents ozone levels 160 based on indicative signals which might be received by processing circuitry 152. Ozone levels 160 are representative of ozone levels sensed by ozone sensor 142 over one or more time periods of operation of air treatment system 136 and/or inerting system 104, with the time periods represented chronologically from an initial time t₀ to a final time t_{f} along the horizontal axis Time. For example, ozone levels 160 include one or more levels 162 indicated by an indicative signal received by processing circuitry 152 over the time period Δt. The time period Δt represents one of a plurality of time periods of operation between t₀ and t_{f}. The plurality of time periods may substantially coincide with the flight operations of an aircraft (e.g., aircraft 102 (FIG. 1). The general increasing trend of the ozone levels 160 of FIG. 4 may result as the ozone removal efficiency of filter 122 decreases over an operational life of filter 122; however this is not required. The ozone levels 160 based on indicative signals received by processing circuitry 152 may show an increasing trend, a decreasing trend, a substantially continuous trend, or some combination over a monitoring period from t₀ to t_{f}.

Within the time period Δt, each of the one or more levels 162 may be indicative of an individual ozone level O_{T} sensed at particular point in time within Δt by ozone sensor 142. For example, each of the one or more levels 162 may be based on a discrete indicative signal sent from ozone sensor 142 to processing circuitry 152 according to a programmed sampling rate or some other time schedule. In examples, the one or more levels 162 may be based on a substantially continuous signal generated by ozone sensor 142 over the time period Δt.

Processing circuitry 152 may be configured to interpret the indicative signals received from ozone sensor 142 during a monitoring period from t₀ to t_{f}. Processing circuitry 152 may be configured to identify an end-of-life criteria for filter 122, based on the indicative signals received from ozone sensor 142. For example, processing circuitry 152 may be configured to identify when an individual ozone level O_{T} based on indicative signals received from ozone sensor 142 equals and/or exceeds a threshold a_{T}. Identification of the level a_{T} in the filtered air supplied from filter effluent 144 may indicate that filter 122 is failing to remove ozone to a level that may be desired (e.g., for the protection of separator 126). Processing circuitry 152 may be configured to generate an indication and/or output (e.g., using output device 156) when the level a_{T} is identified. The indication and/or output may serve to alert an operator that filter 122 should be maintained and/or replaced in order to reduce an ozone exposure of downstream components of filter 122 (e.g., separator 126).

In examples, processing circuitry 152 is configured to determine an ozone dose 164 based on the indicative signals received since the commencement of a monitoring period (e.g., since the time to). The ozone dose 164 may be indicative of, for example, a total amount of ozone in the filtered air supplied from filter effluent 144 since the commencement of the monitoring period. Hence, the ozone dose 164 may be indicative of an amount of ozone to which one or more components downstream of filter 122 (e.g., separator 126) have been exposed over the monitoring period. In examples, processing circuitry 152 may be configured to substantially integrate the indicative signals received from ozone sensor 142 in order to determine the ozone dose 164. Processing circuitry 152 may be configured to identify when the ozone dose 164 equals and/or exceeds a threshold a_{D}. Processing circuitry 152 may be configured to generate an indication and/or output (e.g., using output device 156) when the level a_{D} of ozone dose 164 is identified. The indication and/or output may serve to alert an operator that filter 122 should be maintained and/or replaced in order to reduce an ozone exposure of downstream components of filter 122 (e.g., separator 126). In examples, processing circuitry 152 is configured to generate a signal history based on the indicative signals received over one or more monitoring periods. The signal history may indicate, for example, the ozone level, ozone dose, or another parameter based on the indicative signals over the one or more time periods.

Processing circuitry 152 may be configured to identify other parameters associated with the ozone level of the filtered air supplied from effluent side 144 of filter 122. For example, processing circuitry 152 may be configured to determine a rate-of-change (e.g., a trend of the ozone levels 160) using the indicative signals received from ozone sensor 142. Processing circuitry 152 may be configured to identify an inflection (e.g., a change in the rate-of-change of the ozone levels 160) using the indicative signals received from ozone sensor 142. Processing circuitry 152 may be configured to determine a parameter defined by an equation and/or function in which one or more of the indicative signals are used as values in the equation and/or function. Processing circuitry 152 may be configured to generate an indication and/or output (e.g., using output device 156) when a parameter value associated with the indicative signals is identified.

Thus, air treatment system 136 may be configured to monitor the ozone removal performance of filter 122, in order to limit and/or avoid subjecting portions of the system downstream of filter 122 (e.g., separator 126) to higher ozone levels than might be desired. Air treatment system 136 may be configured to identify an end-of-life criteria for filter 122 based on an ozone level of the filter air issuing from filter effluent 144. (e.g., threshold a_{T}, an ozone dose a_{D}, or some other criteria based on the indicative signals received from ozone sensor 142). Air treatment system 136 may be configured to alert an operator to the end-of-life criteria to generate, for example, an indication that maintenance and/or replacement of filter 122 should be performed.

Returning to FIG. 3, ozone converter 114 of inerting system 104 may be configured to receive an air stream via inlet conduit 110 and supply a flow of treated air, where the treated air has a lower ozone concentration than the air stream supplied via inlet conduit 110. In examples, ozone converter 114 is configured to cause a decomposition of ozone (O₃) to oxygen (O₂). Ozone converter 114 may be configured to bring the air stream into contact with a catalyst. In examples, the catalyst is a metal oxide such as silver oxide, manganese oxide, a precious metal oxide, and/or others. Ozone converter 114 may include a framework configured to support the catalyst when the air stream encounters the catalyst. The framework may be, for example, a honeycomb defining a plurality of gas flow channels, one or more fins configured to extend into the air stream, a fabric configured to allow the air stream to flow therethrough, and/or other frameworks.

In examples, ozone converter 114 includes a housing 166 (“OC housing 166”) defining an inlet 168 of ozone converter 114 (“OC inlet 168”) and an outlet 170 of ozone converter 114 (“OC outlet 170”). OC housing 166 may be configured to cause a flow of air entering via OC inlet 168 to encounter the catalyst before exiting via OC outlet 170. Ozone converter 114 may be configured to supply a flow of treated air into conduit 116. In examples, OC inlet 168 is in fluid communication with a flow path defined by inlet conduit 110, such that inlet conduit 110 and OC inlet 168 define a confined flow pathway for the air stream entering ozone converter 114. In examples, OC outlet 170 is in fluid communication with a flow path defined by conduit 116, such that OC outlet 170 and inlet conduit 110 define a confined flow pathway for the treated air exiting ozone converter 114. OC housing 166 may be configured to mechanically support a frame work supporting a catalyst and/or a catalyst bed when the air stream encounters the frame work and/or a catalyst bed.

Inerting system 104 may be configured to reduce the temperature of the treated air supplied by ozone converter 114 in order to, for example, improve the operation and/or meet an operational parameter of one or more components of inerting system 104. In examples, heat exchanger 118 is configured to cause a heat transfer from the treated air supplied by ozone converter 114. Heat exchanger 118 may be configured to cause the heat transfer from the treated air to a coolant fluid within one or more fluid pathways defined by heat exchanger 118. In examples, heat exchanger 118 is configured to cause the heat transfer to a cooling air stream originating from an environment surrounding aircraft 102 (FIG. 1). For example, the cooling air stream may be generated by a ram-air intake of aircraft 102 configured to generate the cooling air stream as aircraft 102 moves through the atmosphere (e.g., during a flight). In examples, inerting system 104 (e.g., heat exchanger 118) is configured to cool the treated air from a temperature of about 300° F. To 500° F. (about 149° C. to about 260° C.) to a temperature of about 180° F. To 200° F. (about 82° C. to about 93° C.).

In examples, heat exchanger 118 includes a housing 172 (“HX housing 172”) defining an inlet 174 of heat exchanger 118 (“HX inlet 174) and an outlet 176 of heat exchanger 118 (“HX outlet 176”). HX housing 172 may be configured to cause a flow of air treated air entering via HC inlet 174 (e.g., from conduit 116) to transfer heat (e.g., to cool) before exiting via HX outlet 176. HX housing 172 may be configured to cause the treated air received via HX inlet 174 to issue from HX outlet 176 into a flow passage defined by conduit 120. In examples, HX inlet 174 is in fluid communication with the flow path defined by conduit 116, such that HX inlet 174 and conduit 116 define a confined flow pathway for the treated air entering heat exchanger 118. In examples, HX outlet 176 is in fluid communication with a flow path defined by conduit 120, such that HX outlet 176 and conduit 120 define a confined flow pathway for the treated air exiting heat exchanger 118.

Air treatment system 136 within inerting system 104 may include a filter assembly including filter 122. Filter 122 may be configured to remove some portion of the ozone remaining within the treated air after passage through ozone converter 114 and heat exchanger 118, as well as other substances such as hydrocarbons, water and particulates. In examples, filter 122 includes a High-Efficiency Particulate Arrestance (HEPA) filter. The filter may include one or more absorbents and/or adsorbants configured to remove ozone from a fluid (e.g., gas) by, for example, absorption and/or adsoption. The filter may include one or more catalytic agents configured to remove ozone from a fluid by, for example, causing a reaction with ozone. Filter 122 may be configured to contact a flow of filtered air on an influent side 178 of filter 122 (“filter influent 178”) and supply a flow of filtered air from filter effluent 144.

Filter assembly 138 may include a housing 180 (“filter housing 180”) configured to mechanically support filter 122 when the air stream encounters filter influent 178. Filter housing 180 may define an inlet 182 (“filter inlet 182) and an outlet 184 (“filter outlet 184”). Filter housing 180 may be configured to cause a flow of treated air entering via filter inlet 182 to encounter the filter influent 178 and issue from filter effluent 144 before exiting via filter outlet 184. In examples, filter inlet 182 is in fluid communication with a flow path defined by a portion of conduit 120, such that filter inlet 182 and conduit 120 define a confined flow pathway for the treated air entering filter assembly 138. In examples, filter outlet 184 is in fluid communication with a flow path defined by conduit 124, such that filter outlet 184 and conduit 124 define a confined flow pathway for the filtered air exiting filter assembly 138.

As discussed, air treatment system 136 may include sample line 146, flow regulator 150, ozone sensor 142, processing circuitry 152, output device 156, and/or communication links 154, 158 configured to sense an ozone level of the filtered air issued through filter effluent 144.

Separator 126 may be configured to receive filtered air supplied by filter effluent 144 and separate the filtered air into a nitrogen-enriched stream and an oxygen-enriched stream. Separator 126 may include an air separation membrane 186 configured to separate the filtered air from the filter into the nitrogen-enriched air and the oxygen-enriched air. Air separation membrane 186 may be a selectively permeable membrane configured to substantially discriminate between oxygen and inert gases, such as nitrogen. In examples, air separation membrane 186 defines a retentate side 188 and a permeate side 190 opposite retentate side 188. Air separation membrane 186 may be configured such that, as the filtered air encounters retentate side 188, oxygen from the filtered air passes (e.g., preferentially over nitrogen) from retentate side 188 to permeate side 190. In examples, separator 126 is configured such that air separation membrane 186 substantially defines a boundary between the nitrogen-enriched air and the oxygen-enriched air.

Air separation membrane 186 may have any shape, and separator 126 may include any number of air separation membranes. In examples, air separation membrane 186 is a tubular membrane defining a passageway 194 configured to receive a flow of filtered air from filter effluent 144. Passageway 194 may be defined by retentate side 188 of air separation membrane 186. Air separation membrane 186 may be configured such that, as filtered air flows through passageway 194, oxygen within the filtered air permeates through air separation membrane 186 preferentially over nitrogen within the filtered air. Hence, as the filtered air travels through passageway 194, an oxygen concentration of the filtered air may decrease as the nitrogen concentration of the filtered air increases. Additionally, as the filtered air travels through passageway 194, an oxygen-enriched stream may develop on the permeate side 190 of air separation membrane 186. Thus, air separation membrane 186 may be configured to generate a nitrogen-enriched stream in fluid communication with retentate side 188 and an oxygen-enriched stream in fluid communication with permeate side 190. In examples, separator 126 includes a plurality of air separation membranes with each air separation membrane configured to generate a nitrogen-enriched stream and an oxygen-enriched stream in like manner to that described for air separation membrane 186.

Separator assembly 140 may include a separator housing 196. Separator housing 196 may be configured to mechanically support separator 126 when the filtered air encounters separator 126 (e.g., encounters retentate side 188 of air separation membrane 186). Separator housing 196 may define an inlet 198 (“separator inlet 198) and an outlet 202 (“separator outlet 202”). Separator housing 196 may be configured to cause treated air entering via separator inlet 198 to encounter separator 126 (e.g., encounter retentate side 188 of air separation membrane 186). Separator housing 196 may be configured to cause a nitrogen-enriched stream to issue from separator outlet 202. In examples, separator inlet 198 is in fluid communication with a flow path defined by a portion of conduit 124, such that separator inlet 198 and conduit 124 define a confined flow pathway for the filtered air entering separator 126. In examples, separator outlet 202 is in fluid communication with a flow path defined by a portion of conduit 130, such that separator outlet 202 and conduit 130 define a confined flow pathway for the nitrogen-enriched stream exiting separator 126. Further, separator housing 196 may define a permeate vent 206 in fluid communication with separator 126. Permeate vent 206 may be in fluid communication with permeate side 190 of air separation membrane 186. Permeate vent 206 may be configured to cause the oxygen-enriched stream to issue from permeate vent 206.

Conduit 130 may be configured to supply the nitrogen-enriched air to a volume (e.g., an ullage space) defined by fuel tank 106. Fuel tank 106 may be part of a fuel delivery system configured to deliver the fuel for combustion in engine (e.g., aircraft engine 108 (FIG. 1)). The ullage space may be a volume defined by an interior surface 208 of fuel tank 106 and a surface 210 of the combustible fuel within fuel tank 106. In some examples, inerting system 104 may include a valve 212 configured to divert some portion of the nitrogen-enriched air from conduit 130 to an NEA excess conduit 214 based on a condition of the ullage space of fuel tank 106. Valve 212 may be configured to position based on commands received from processing circuitry (e.g., processing circuitry 134 (FIG. 1)). Hence, inerting system 104 and/or air treatment system 136 may be configured to receive a stream of air and separate the stream of air into nitrogen-enriched air and oxygen-enriched air, and deliver the nitrogen-enriched stream to the ullage space of fuel tank 106. Inerting system 104 and/or air treatment system 136 may be configured to deliver the nitrogen-enriched stream to provide a substantially non-combustible mixture of gases within the ullage space of fuel tank 106.

Although illustrated at FIG. 3 as substantially separate components, two or more of OC housing 166, HX housing 172, filter housing 180, and/or separator housing 196 may be configured as portions of a mechanically unified housing (e.g., a substantially unitary housing and/or two or more housings mechanically engaged to behave as a substantially rigid body). One or more portions of inlet conduit 110, conduit 116, conduit 120, ECS outlet 128, conduit 124, and/or conduit 130 may be defined by and/or mechanically supported by the mechanically unified housing. For example, inerting system 104 may include a mechanically unified housing configured to mechanically support ozone converter 114, heat exchanger 118, and/or conduit 116. Inerting system 104 may include a mechanically unified housing configured to support filter 122, separator 126, and/or conduit 124. Sample line 146, flow regulator 150, and/or ozone sensor 142 may be mechanically supported by one or more of OC housing 166, HX housing 172, filter housing 180, and/or separator housing 196, or may be mechanically supported in some other manner.

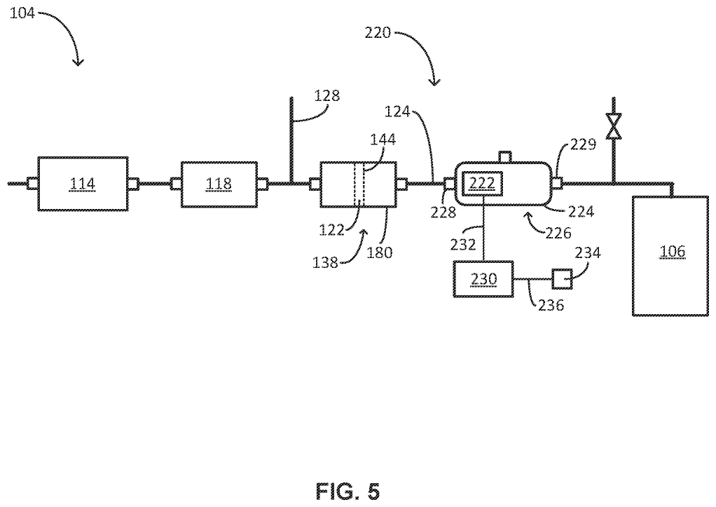

FIG. 5 schematically illustrates an air treatment system 220 having an ozone sensor 222 configured to sense an ozone level of filtered air within a separator housing 224 of a separator assembly 226. Separator housing 224 defines separator inlet 228 and separator outlet 229. Ozone sensor 222 is in communication with processing circuitry 230 via communication link 232, and processing circuitry 230 is in communication with output device 234 via communication link 236. Ozone sensor 222, separator housing 224, separator assembly 226, separator inlet 228, separator outlet 229, processing circuitry 230, communication link 232, output device 234, and communication link 236 may be examples of ozone sensor 142, separator housing 196, separator assembly 140, separator inlet 198, separator outlet 202, processing circuitry 152, communication link 154, output device 156, and communication link 158 respectively. Air treatment system 220 includes filter assembly 138 and conduit 124.

Ozone sensor 222 is configured to sense an ozone level within a flow passage defined by separator housing 224 of air separator assembly 226. Separator assembly 226 may be configured to mechanically support ozone sensor 222. In examples, separator assembly 226 is configured to mechanically support ozone sensor 222 within a flow passage defined by separator assembly 226 for the passage of a flow of filtered air (e.g., from filter 122. In examples, separator assembly 226 mechanically supports ozone sensor 222 such that ozone sensor 142 encounters a flow of filtered air entering separator assembly 226 via separator inlet 228. Separator assembly 226 may mechanically supports ozone sensor 222 such that ozone sensor 142 encounters the flow of filtered air in a flow path defined by separator assembly 226 and including separator inlet 228 and separator outlet 229. Ozone sensor 222 may be positioned substantially within a volume defined by separator housing 224.

In examples, ozone sensor 222 is configured to sense an ozone level within a flow passage in fluid communication with a retentate side of an air separation membrane (e.g., retentate side 188 of air separation membrane 186). Ozone sensor 222 may be configured to sense an ozone level within a flow path defined by separator assembly 226 and including separator inlet 228 and the retentate side of the air separation membrane. In examples, separator assembly 226 mechanically supports ozone sensor 222 such that ozone sensor 142 encounters a flow of filtered air. In examples, separator assembly 226 is configured to mechanically support ozone sensor 222 the flow path defined by separator assembly 226 and including separator inlet 228 and the retentate side of the air separation membrane.

Processing circuitry 152, 230, as well as other control circuitry described herein including processing circuitry 134 of FIG. 1, can comprise any suitable arrangement of hardware, software, firmware, or any combination thereof, to perform the techniques attributed to processing circuitry 152, 230, 134 herein. For example, processing circuitry 152, 230, 134 may include any one or more microprocessors, digital signal processors (DSPs), application specific integrated circuits (ASICs), field programmable gate arrays (FPGAs), or any other equivalent integrated or discrete logic circuitry, as well as any combinations of such components. Processing circuitry 152, 230, 134 may be located adjacent to or within some enclosure defined by inerting system 104 and/or air treatment system 136, 220, or may be within a controller housing configured to remain substantially separate from a housing of inerting system 104 and/or air treatment system 136, 220.

Communication links 154, 158, 232, 236, as well as other communication links described herein may be hard-line and/or wireless communications links. In some examples, communication links 154, 158, 232, 236 may comprise some portion of processing circuitry 152, 230, 134. Communication links 154, 158, 232, 236 may comprise a wired connection, a wireless Internet connection, a direct wireless connection such as wireless LAN, Bluetooth™, Wi-Fi™, and/or an infrared connection. Communication links 154, 158, 232, 236 may utilize any wireless or remote communication protocol.

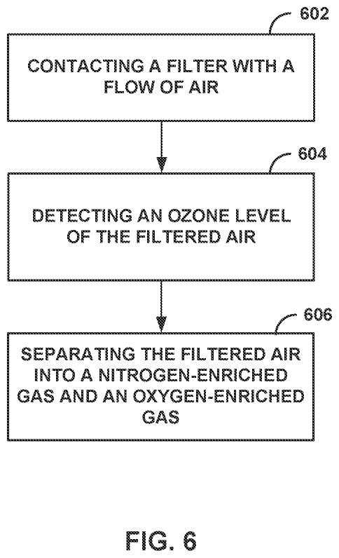

FIG. 6 illustrates a flow diagram of an example technique for generating a nitrogen-enriched gas. Although the technique is mainly described with reference to inerting system 104 and air treatment system 136, in other examples, the technique may be used with air treatment system 220 or another inerting system or air treatment system. In addition, processing circuitry 152, 230, 134 alone or in combination with control circuitry of other devices can perform any part of the technique shown in FIG. 6.

The technique includes contacting a filter 122 with a flow of air (502). The flow of air may be flow of treated air issued by an ozone converter 114 and/or heat exchanger 118. In examples, the technique includes contacting the flow of air with a filter influent 178 of filter 122. The technique may include removing ozone from the stream of air using filter 122. The technique may include issuing a flow of filtered air from filter effluent 144. In examples, the technique includes issuing the filtered air from filter effluent 144, where the filtered air has a lower ozone level than the flow of air contacting filter influent 178. In examples, the technique includes receiving the stream of air through a filter inlet 182 defined by a filter housing 180 and issuing the filtered air through a filter outlet 184 defined by filter housing 180.

The technique includes detecting an ozone level in the filtered air issuing from filter effluent 144 using ozone sensor 142 (504). In examples, the technique includes withdrawing a portion of filtered air from a flow path defined by conduit 124 and detecting an ozone level in the portion of filtered air. The technique may include withdrawing the portion of filtered air through sample line 146. In examples, the technique includes positioning ozone sensor 142 within conduit 124 or within a flow path defined by separator housing 196 and/or filter housing 180 and detecting an ozone level of the filtered air within the flow path.

The technique may include communicating a signal indicating the ozone level sensed from ozone sensor 142 to processing circuitry 152 using communication link 154. The technique may include monitoring the indicative signal using processing circuitry 152. The technique may include determining (e.g., using processing circuitry 152) the indicative signal meets or exceeds a threshold ar. The technique may include using processing circuitry 152 to generate an indication and/or output to output device 156 when the threshold a_{T} is identified. In examples, the technique includes maintaining and/or replacing filter 122 when processing circuitry 152 indicates the threshold ar has been met or exceeded.

In examples, the technique monitoring one or more indicative signals received from ozone sensor 142 over a time period using processing circuitry 152. The technique may include determining an ozone dose using the processing circuitry 152 based on the indicative signals received. In examples, the technique includes substantially integrating the indicative signals of the time period using processing circuitry 152. The technique may include determining (e.g., using processing circuitry 152) when an ozone dose meets or exceeds a threshold a_{D}. In examples, the technique may include using processing circuitry 152 to generate an indication and/or output to output device 156 when the level a_{D} is identified. In examples, the technique includes maintaining and/or replacing filter 122 when processing circuitry 152 indicates the threshold a_{D} has been met or exceeded.

The technique may include separating the filtered air into a nitrogen enriched stream and an oxygen-enriched stream using separator 126 (506). The technique may include contacting the filtered air and a retentate side 188 of air separation membrane 186. The technique may include causing oxygen within the filtered air to permeate through air separation membrane 186 to a permeate side 190 at a greater rate than nitrogen within the filtered air. In examples, the technique includes issuing the nitrogen enriched stream from separator 126. In examples, the technique includes receiving filtered air through separator inlet 198 defined by separator housing 196 and issuing the nitrogen-enriched stream through separator outlet 202 defined by separator housing 196.

In examples, the technique includes supplying an air stream to ozone converter 114 prior to contacting filter 122 with the treated air. The technique may include removing ozone from the air stream using ozone converter 114. The technique may include issuing treated air from ozone converter 114, where the treated air has a lower ozone level than the air stream. In examples, the technique includes supplying a bleed air from an engine 108 of an aircraft 102 to ozone converter 114. The technique may include cooling the treated air using heat exchanger 118 prior to contacting filter 122 with the treated air. In examples, the technique includes receiving the air stream through OC inlet 168 defined by OC housing 166 and issuing the treated air through OC outlet 170 defined by OC housing 166. In examples, the technique includes receiving the air stream through OC inlet 168 defined by OC housing 166 and issuing the treated air through OC outlet 170 defined by OC housing 166.

In examples, the technique includes supplying the nitrogen-enriched stream to a fuel tank 106. The technique may include supplying the nitrogen-enriched stream to an ullage space. The ullage space may be a volume defined by an interior surface 208 of fuel tank 106 and a surface 210 of the combustible fuel within fuel tank 106. In examples, the technique includes supplying the nitrogen-enriched stream as a volume of the ullage space increases (e.g., over the course of an aircraft flight).

The techniques described in this disclosure, including those attributed to processing circuitry 152, 230, 134 and processing circuitry, sensors, or various constituent components, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in any suitable device. Processing circuitry, control circuitry, and sensing circuitry, as well as other processors, controllers, and sensors described herein, may be implemented at least in part as, or include, one or more executable applications, application modules, libraries, classes, methods, objects, routines, subroutines, firmware, and/or embedded code, for example. In addition, analog circuits, components and circuit elements may be employed to construct one, some or all of the control circuitry and sensors, instead of or in addition to the partially or wholly digital hardware and/or software described herein. Accordingly, analog or digital hardware may be employed, or a combination of the two.

In one or more examples, the functions described in this disclosure may be implemented in hardware, software, firmware, or any combination thereof. If implemented in software, the functions may be stored on, as one or more instructions or code, a computer-readable medium and executed by a hardware-based processing unit. The computer-readable medium may be an article of manufacture including a non-transitory computer-readable storage medium encoded with instructions. Instructions embedded or encoded in an article of manufacture including a non-transitory computer-readable storage medium encoded, may cause one or more programmable processors, or other processors, to implement one or more of the techniques described herein, such as when instructions included or encoded in the non-transitory computer-readable storage medium are executed by the one or more processors. Example non-transitory computer-readable storage media may include RAM, ROM, programmable ROM (PROM), erasable programmable ROM (EPROM), electronically erasable programmable ROM (EEPROM), flash memory, a hard disk, a compact disc ROM (CD-ROM), a floppy disk, a cassette, magnetic media, optical media, or any other computer readable storage devices or tangible computer readable media.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

The functionality described herein may be provided within dedicated hardware and/or software modules. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components. Also, the techniques could be fully implemented in one or more circuits or logic elements.

The present disclosure includes the following examples.

Example 1: An air treatment system comprising: a filter configured to receive a flow of treated air comprising ozone and generate a flow of filtered air, wherein the flow of filtered air comprises a lower concentration of ozone than the flow of treated air; a separator configured to receive the flow of filtered air from the filter, wherein the separator is configured to separate the flow of filtered air into a flow of nitrogen-enriched gas and a flow of oxygen-enriched gas; and an ozone sensor configured to detect an ozone level in the flow of filtered air.

Example 2: The air treatment system of example 1, further comprising processing circuitry configured to receive a signal indicative of the ozone level from the ozone sensor, wherein the processing circuitry is configured to generate an output representative of the ozone level based on the indicative signal.

Example 3: The air treatment system of example 2, wherein the processing circuitry is configured to: receive the indicative signal over a time period; and determine an ozone dose over the time period, wherein the ozone dose is indicative of a quantity of ozone present in the filtered air over the time period.

Example 4: The air treatment system of example 2 or 3, wherein the processing circuitry is configured to: receive the indicative signal over a time period; and generate a signal history over the time period, wherein the signal history is indicative of a quantity of ozone present in the filtered air at one or more times within the time period.

Example 5: The air treatment system of any of examples 2-4, further comprising an output device, wherein the processing circuitry is configured to: recognize when the ozone level equals or exceeds a threshold, and indicate to a user, using the output device, that the ozone level has equaled or exceeded the threshold.

Example 6: The air treatment system of any of examples 1-5, further comprising a conduit configured to channel the filtered air from the filter to the separator, wherein the ozone sensor is configured to detect an ozone level in the conduit.

Example 7: The air treatment system of any of examples 1-6, wherein the filter is configured to remove at least one of water or hydrocarbons from the flow of treated air to cause the flow of filtered air to comprise a lower concentration of the at least one of the water or the hydrocarbons than the treated air.

Example 8: The air treatment system of any of examples 1-7, wherein the separator comprises an air separation membrane.

Example 9: The air treatment system of example 8, wherein the separator includes: an separator inlet configured to contact the received flow of filtered air with a retentate side of the air separation membrane, a permeate vent configured to discharge the flow of oxygen-enriched gas from a permeate side of the air separation membrane, and a separator outlet configured to discharge the flow of nitrogen-enriched gas from the retentate side of the air separation membrane.

Example 10: The air treatment system of any of examples 1-9, further comprising a fuel tank defining a volume configured to hold a combustible fuel, wherein the separator is configured to discharge the flow of nitrogen enriched gas to the volume of fuel tank.

Example 11: The air treatment system of any of examples 1-10, further comprising an ozone converter configured to receive an air stream comprising ozone and generate the flow of treated air, wherein the flow of treated air comprises less ozone than the air stream.

Example 12: The air treatment system of example 11, wherein the ozone converter is configured to convert some portion of the ozone comprising the air stream into diatomic oxygen.

Example 13: The air treatment system of example 11 or 12, further comprising a heat exchanger configured to receive the flow of treated air from the ozone converter and reduce a temperature of the flow of treated air, wherein the filter is configured to receive the flow of treated air from the heat exchanger.

Example 14: The air treatment system of any of examples 1-13, further comprising: a filter housing supporting the filter and defining a filter inlet and a filter outlet, wherein the filter housing is configured to receive the treated air at the filter inlet and supply the filtered air at the filter outlet; a conduit configured to receive the filtered air; and a separator housing supporting the separator and defining a separator inlet and a separator outlet, wherein the separator housing is configured to receive the filtered air from the conduit and supply the nitrogen-enriched gas at the separator outlet.

Example 15: An air treatment system comprising: a filter assembly comprising: a filter configured to reduce an ozone level in a flow of air when the flow of air encounters the filter; a filter inlet configured to receive treated air comprising ozone and cause the treated air to encounter the filter; and a filter outlet configured to channel filtered air from the filter, wherein the filtered air comprises a lower concentration of ozone than the treated air; a separator assembly comprising: an air separation membrane configured to separate the filtered air into a nitrogen-enriched gas and an oxygen-enriched gas when the filtered air encounters the air separation membrane; a separator inlet configured to receive filtered air from the filter outlet and cause the filtered air to encounter the membrane; and a separator outlet configured to channel the nitrogen-enriched gas from the membrane; and an ozone sensor configured to detect an ozone level of the filtered air received by the separator inlet.

Example 16: The air treatment system of example 15, wherein the filter is configured to reduce the ozone level in the flow of air when the flow of air flows from an influent side of the filter to an effluent side of the filter, and wherein the filter inlet is configured to cause the treated air to encounter the influent side and the filter outlet is configured to channel filtered air from the effluent side.

Example 17: The air treatment system of example 15 or 16, further comprising processing circuitry configured to receive a signal indicative of the ozone level from the ozone sensor, wherein the processing circuitry is configured to generate an output representative of the ozone level based on the indicative signal.

Example 18: The air treatment system of any of examples 15-17, further comprising: an ozone converter comprising a converter outlet, wherein the ozone converter is configured to receive an air stream comprising ozone and generate the treated air at the converter outlet, wherein the treated air comprises less ozone than the air stream, and wherein the filter inlet configured to receive the treated air from the converter outlet; and a fuel tank defining a volume configured to hold a combustible fuel, wherein the separator outlet is configured to discharge the flow of nitrogen enriched gas to the volume of fuel tank.

Example 19: A method, comprising: contacting a filter with a flow of air comprising ozone and removing some portion of the ozone to generate filtered air; detecting an ozone level of the filtered air using an ozone sensor; and separating, via a separator, the filtered air into a nitrogen-enriched gas and an oxygen-enriched gas.

Example 20: The method of example 19, further comprising: transmitting a signal indicative of the ozone level to processing circuitry using the ozone sensor; and generating an output representative of the ozone level using the processing circuitry.

Various examples have been described. These and other examples are within the scope of the following claims.

What is claimed is:

1. An air treatment system comprising:
a filter configured to receive a flow of treated air comprising ozone and generate a flow of filtered air, wherein the flow of filtered air comprises a lower concentration of ozone than the flow of treated air;
a separator configured to receive the flow of filtered air from the filter, wherein the separator is configured to separate the flow of filtered air into a flow of nitrogen-enriched gas and a flow of oxygen-enriched gas; and
an ozone sensor configured to detect an ozone level in the flow of filtered air.

2. The air treatment system of claim 1, further comprising processing circuitry configured to receive a signal indicative of the ozone level from the ozone sensor, wherein the processing circuitry is configured to generate an output representative of the ozone level based on the indicative signal.

3. The air treatment system of claim 2, wherein the processing circuitry is configured to:
receive the indicative signal over a time period; and
determine an ozone dose over the time period, wherein the ozone dose is indicative of a quantity of ozone present in the filtered air over the time period.

4. The air treatment system of claim 2, wherein the processing circuitry is configured to:
receive the indicative signal over a time period; and
generate a signal history over the time period, wherein the signal history is indicative of a quantity of ozone present in the filtered air at one or more times within the time period.

5. The air treatment system of claim 2, further comprising an output device, wherein the processing circuitry is configured to:
recognize when the ozone level equals or exceeds a threshold, and
indicate to a user, using the output device, that the ozone level has equaled or exceeded the threshold.

6. The air treatment system of claim 1, further comprising a conduit configured to channel the filtered air from the filter to the separator, wherein the ozone sensor is configured to detect an ozone level in the conduit.

7. The air treatment system of claim 1, wherein the filter is configured to remove at least one of water or hydrocarbons from the flow of treated air to cause the flow of filtered air to comprise a lower concentration of the at least one of the water or the hydrocarbons than the treated air.

8. The air treatment system of claim 1, wherein the separator comprises an air separation membrane.

9. The air treatment system of claim 8, wherein the separator includes:
an separator inlet configured to contact the received flow of filtered air with a retentate side of the air separation membrane,
a permeate vent configured to discharge the flow of oxygen-enriched gas from a permeate side of the air separation membrane, and
a separator outlet configured to discharge the flow of nitrogen-enriched gas from the retentate side of the air separation membrane.

10. The air treatment system of claim 1, further comprising a fuel tank defining a volume configured to hold a combustible fuel, wherein the separator is configured to discharge the flow of nitrogen enriched gas to the volume of fuel tank.

11. The air treatment system of claim 1, further comprising an ozone converter configured to receive an air stream comprising ozone and generate the flow of treated air, wherein the flow of treated air comprises less ozone than the air stream.

12. The air treatment system of claim 11, wherein the ozone converter is configured to convert some portion of the ozone comprising the air stream into diatomic oxygen.

13. The air treatment system of claim 11, further comprising a heat exchanger configured to receive the flow of treated air from the ozone converter and reduce a temperature of the flow of treated air, wherein the filter is configured to receive the flow of treated air from the heat exchanger.

14. The air treatment system of claim 1, further comprising:
a filter housing supporting the filter and defining a filter inlet and a filter outlet, wherein the filter housing is configured to receive the treated air at the filter inlet and supply the filtered air at the filter outlet;
a conduit configured to receive the filtered air; and
a separator housing supporting the separator and defining a separator inlet and a separator outlet, wherein the separator housing is configured to receive the filtered air from the conduit and supply the nitrogen-enriched gas at the separator outlet.

15. An air treatment system comprising:
a filter assembly comprising:
a filter configured to reduce an ozone level in a flow of air when the flow of air encounters the filter;
a filter inlet configured to receive treated air comprising ozone and cause the treated air to encounter the filter; and
a filter outlet configured to channel filtered air from the filter, wherein the filtered air comprises a lower concentration of ozone than the treated air;
a separator assembly comprising:
an air separation membrane configured to separate the filtered air into a nitrogen-enriched gas and an oxygen-enriched gas when the filtered air encounters the air separation membrane;
a separator inlet configured to receive filtered air from the filter outlet and cause the filtered air to encounter the membrane; and
a separator outlet configured to channel the nitrogen-enriched gas from the membrane; and
an ozone sensor configured to detect an ozone level of the filtered air received by the separator inlet.

16. The air treatment system of claim 15, wherein the filter is configured to reduce the ozone level in the flow of air when the flow of air flows from an influent side of the filter to an effluent side of the filter, and wherein the filter inlet is configured to cause the treated air to encounter the influent side and the filter outlet is configured to channel filtered air from the effluent side.

17. The air treatment system of claim 15, further comprising processing circuitry configured to receive a signal indicative of the ozone level from the ozone sensor, wherein the processing circuitry is configured to generate an output representative of the ozone level based on the indicative signal.

18. The air treatment system of claim 15, further comprising:
an ozone converter comprising a converter outlet, wherein the ozone converter is configured to receive an air stream comprising ozone and generate the treated air at the converter outlet, wherein the treated air comprises less ozone than the air stream, and wherein the filter inlet configured to receive the treated air from the converter outlet; and
a fuel tank defining a volume configured to hold a combustible fuel, wherein the separator outlet is configured to discharge the flow of nitrogen enriched gas to the volume of fuel tank.

19. A method, comprising:
contacting a filter with a flow of air comprising ozone and removing some portion of the ozone to generate filtered air;
detecting an ozone level of the filtered air using an ozone sensor; and
separating, via a separator, the filtered air into a nitrogen-enriched gas and an oxygen-enriched gas.

20. The method of claim 19, further comprising:
transmitting a signal indicative of the ozone level to processing circuitry using the ozone sensor; and
generating an output representative of the ozone level using the processing circuitry.
